(19) United States
(12) Patent Application Publication
(10) Pub. No.: US 2025/0265041 A1
(43) Pub. Date: Aug. 21, 2025

(54) PERFORMING FLOATING-POINT OPERATIONS USING AN EXPANDED-RANGE FLOATING-POINT FORMAT IN PROCESSOR DEVICES

(71) Applicant: QUALCOMM Incorporated, San Diego, CA (US)

(72) Inventor: Andrew Evan Gruber, Arlington, MA (US)

(21) Appl. No.: 18/583,088

(22) Filed: Feb. 21, 2024

(51) Int. Cl. G06F 7/544; G06F 5/01; G06F 7/485; G06F 7/487

(52) U.S. Cl. CPC G06F 7/5443; G06F 5/012; G06F 7/485; G06F 7/4876

(57) ABSTRACT

Performing floating-point operations using an expanded-range floating-point format in processor devices is disclosed herein. In some aspects, a processor device comprises a floating-point unit (FPU) that is configured to perform a floating-point operation using one or more floating-point values interpreted by the FPU according to an expanded-range floating-point format that comprises no sign bit, a plurality of exponent bits including an additional exponent bit relative to a corresponding standard floating-point format, and a plurality of significand bits. The expanded-range floating-point format comprises a same number of bits as the corresponding standard floating-point format. A count of the plurality of significand bits of the expanded-range floating-point format is identical to a count of a plurality of significand bits of the corresponding standard floating-point format, and the significand bits of the expanded-range floating-point format are interpreted in a manner identical to the significand bits of the corresponding standard floating-point format.

### BACKGROUND

### I. Field of the Disclosure

The technology of the disclosure relates generally to handling of floating-point numbers by a processor device, and, in particular, to formats for representing and handling floating-point numbers by a floating-point unit (FPU) of a processor device.

### II. Background

Microprocessors, also referred to herein as “processors,” perform computational tasks for a wide variety of applications by executing instructions to perform logical and mathematical operations on data, including operations using floating-point numbers. As used herein, “floating-point numbers” refer to representations of real numbers using a “significand” that comprises an integer with a specific precision expressing a binary fraction, and an “exponent” that comprises an integer of a specific base. Floating-point numbers are useful in representing numbers of different orders of magnitude using a fixed number of digits. A common floating-point format has been defined by the Institute of Electrical and Electronics Engineers (IEEE), which created a technical standard for floating-point arithmetic known as the IEEE-754 standard. The IEEE-754 standard defines arithmetic formats for floating-point data, and also specifies interchange formats, rounding rules, floating-point operations, and exception handling.

One conventional operation that utilizes floating-point numbers is vector normalization, which may be frequently performed by graphics processing units (GPU) when generating three-dimensional (3D) graphics. Vector normalization involves converting the length of a vector to a value of one (1), and then scaling each vector component accordingly. A conventional algorithm for scaling each vector component includes calculating the square of each vector component, summing the squares, determining the reciprocal square root of the sum, and then multiplying each vector component by the reciprocal square root.

However, calculating the square of each vector component may generate results that exceed the range of 16-bit floating-point (FP16) numbers, even if the vector component itself can be represented by an FP16 value. Thus, conventional GPUs must convert each vector component to a 32-bit floating-point (FP32) value, perform intermediate operations using the FP32 values, and then convert the results back to FP16 values. This requirement for conversion from FP16 values to FP32 values and back again negatively impacts performance and power consumption by the GPU.

### SUMMARY OF THE DISCLOSURE

Aspects disclosed in the detailed description include performing floating-point operations using an expanded-range floating-point format in processor devices. Related apparatus and methods are also disclosed. In this regard, in some exemplary aspects disclosed herein, a processor device includes a floating-point unit (FPU) that is configured to perform floating-point operations using one or more floating-point values that are interpreted according to an expanded-range floating-point format. Where a conventional standard floating-point format comprises a sign bit, a plurality of exponent bits, and a plurality of significand bits, the expanded-range floating-point format includes the same total number of bits and the same number and interpretation of significand bits, but repurposes the sign bit as an additional exponent bit. This enables the expanded-range floating-point format to represent a wider range of positive numbers than the corresponding standard floating-point format, with the same precision.

In some aspects, the FPU may perform the floating-point operation by executing a multiply-accumulate instruction provided by an instruction set architecture (ISA) of the processor device. The multiply-accumulate instruction receives a first input value, a second input value, and a third input value, and returns a first output value. The first input value, the second input value, the third input value, and/or the first output value may be interpreted according to the expanded-range floating-point format. For example, in aspects in which the multiply-accumulate instruction is executed as part of a vector normalization operation, the first input value and the second input value may be interpreted according to the standard floating-point format, while the third input value and the first output value may be interpreted according to the expanded-range floating-point format. Some aspects in which the multiply-accumulate instruction is executed as part of a machine learning (ML) application may provide that the first input value is interpreted according to the expanded-range floating-point format, while the second input value, the third input value, and the first output value may be interpreted according to the standard floating-point format. In response to executing the multiply-accumulate instruction, the FPU multiplies the first input value by the second input value as a product, then sums the product with the third input value as the first output value.

Some aspects may provide that the FPU performs the floating-point operation by executing a reciprocal-square-root instruction that provided by the ISA of the processor device, and that receives a fourth input value and returns a second output value. In such aspects, the fourth input value may be interpreted according to the expanded-range floating-point format, while the second output value is interpreted according to the standard floating-point format. In response to executing the reciprocal-square-root instruction, the FPU calculates the reciprocal square root of the fourth input value as the second output value.

In another aspect, a processor device is disclosed. The processor device, comprising a FPU configured to perform a floating-point operation using one or more floating-point values interpreted by the FPU according to an expanded-range floating-point format that comprises no sign bit, a plurality of exponent bits including an additional exponent bit relative to a corresponding standard floating-point format, and a plurality of significand bits. The expanded-range floating-point format comprises a same number of bits as the corresponding standard floating-point format. A count of the plurality of significand bits of the expanded-range floating-point format is identical to a count of a plurality of significand bits of the corresponding standard floating-point format, and the plurality of significand bits of the expanded-range floating-point format are interpreted in a manner identical to the plurality of significand bits of the corresponding standard floating-point format.

In another aspect, a processor device is disclosed. The processor device comprises means for performing a floating-point operation using one or more floating-point values interpreted according to an expanded-range floating-point format that comprises no sign bit, a plurality of exponent bits including an additional exponent bit relative to a corresponding standard floating-point format, and a plurality of significand bits. The expanded-range floating-point format comprises a same number of bits as the corresponding standard floating-point format. A count of the plurality of significand bits of the expanded-range floating-point format is identical to a count of a plurality of significand bits of the corresponding standard floating-point format, and the plurality of significand bits of the expanded-range floating-point format are interpreted in a manner identical to the plurality of significand bits of the corresponding standard floating-point format.

In another aspect, a method for performing floating-point operations using an expanded-range floating-point format in processor devices is disclosed. The method comprises, performing, by a FPU of a processor device, a floating-point operation using one or more floating-point values interpreted by the FPU according to an expanded-range floating-point format that comprises no sign bit, a plurality of exponent bits including an additional exponent bit relative to a corresponding standard floating-point format, and a plurality of significand bits. The expanded-range floating-point format comprises a same number of bits as the corresponding standard floating-point format. A count of the plurality of significand bits of the expanded-range floating-point format is identical to a count of a plurality of significand bits of the corresponding standard floating-point format, and the plurality of significand bits of the expanded-range floating-point format are interpreted in a manner identical to the plurality of significand bits of the corresponding standard floating-point format.

In another aspect, a non-transitory computer-readable medium is disclosed. The non-transitory computer-readable medium stores computer-executable instructions that, when executed, cause a processor device to perform a floating-point operation using one or more floating-point values interpreted by the processor device according to an expanded-range floating-point format that comprises no sign bit, a plurality of exponent bits including an additional exponent bit relative to a corresponding standard floating-point format, and a plurality of significand bits. The expanded-range floating-point format comprises a same number of bits as the corresponding standard floating-point format. A count of the plurality of significand bits of the expanded-range floating-point format is identical to a count of a plurality of significand bits of the corresponding standard floating-point format, and the plurality of significand bits of the expanded-range floating-point format are interpreted in a manner identical to the plurality of significand bits of the corresponding standard floating-point format.

### BRIEF DESCRIPTION OF THE FIGURES

FIGS. 1A and 1B are block diagrams illustrating an exemplary standard floating-point number format and an exemplary expanded-range floating-point format, respectively, according to some aspects;

FIG. 2 is a block diagram of an exemplary processor-based device including a processor device comprising a floating-point unit (FPU) configured to perform floating-point operations using the expanded-range floating-point format of FIG. 1B, according to some aspects;

FIGS. 3A and 3B illustrate exemplary instructions and floating-point operations that may be performed by the FPU of FIG. 2 using the expanded-range floating-point format of FIG. 1B, according to some aspects;

FIG. 4 provides a flowchart illustrating exemplary operations of the FPU of FIG. 2 for performing floating-point operations using the expanded-range floating-point format, according to some aspects; and

FIG. 5 is a block diagram of an exemplary processor-based device that can include the FPU of FIG. 2.

### DETAILED DESCRIPTION

With reference now to the figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects. The terms “first,” “second,” “third,” and the like used herein are intended to distinguish between similarly named elements, and do not indicate an ordinal relationship between such elements unless otherwise indicated.

Aspects disclosed in the detailed description include performing floating-point operations using an expanded-range floating-point format in processor devices. Related apparatus and methods are also disclosed. In this regard, in some exemplary aspects disclosed herein, a processor device includes a floating-point unit (FPU) that is configured to perform floating-point operations using one or more floating-point values that are interpreted according to an expanded-range floating-point format. Where a conventional standard floating-point format comprises a sign bit, a plurality of exponent bits, and a plurality of significand bits, the expanded-range floating-point format includes the same total number of bits and the same number and interpretation of significand bits, but repurposes the sign bit as an additional exponent bit. This enables the expanded-range floating-point format to represent a wider range of positive numbers than the corresponding standard floating-point format, with the same precision.

In some aspects, the FPU may perform the floating-point operation by executing a multiply-accumulate instruction provided by an instruction set architecture (ISA) of the processor device. The multiply-accumulate instruction receives a first input value, a second input value, and a third input value, and returns a first output value. The first input value, the second input value, the third input value, and/or the first output value may be interpreted according to the expanded-range floating-point format. For example, in aspects in which the multiply-accumulate instruction is executed as part of a vector normalization operation, the first input value and the second input value may be interpreted according to the standard floating-point format, while the third input value and the first output value may be interpreted according to the expanded-range floating-point format. Some aspects in which the multiply-accumulate instruction is executed as part of a machine learning (ML) application may provide that the first input value is interpreted according to the expanded-range floating-point format, while the second input value, the third input value, and the first output value may be interpreted according to the standard floating-point format. In response to executing the multiply-accumulate instruction, the FPU multiplies the first input value by the second input value as a product, then sums the product with the third input value as the first output value.

Some aspects may provide that the FPU performs the floating-point operation by executing a reciprocal-square-root instruction that provided by the ISA of the processor device, and that receives a fourth input value and returns a second output value. In such aspects, the fourth input value may be interpreted according to the expanded-range floating-point format, while the second output value is interpreted according to the standard floating-point format. In response to executing the reciprocal-square-root instruction, the FPU calculates the reciprocal square root of the fourth input value as the second output value.

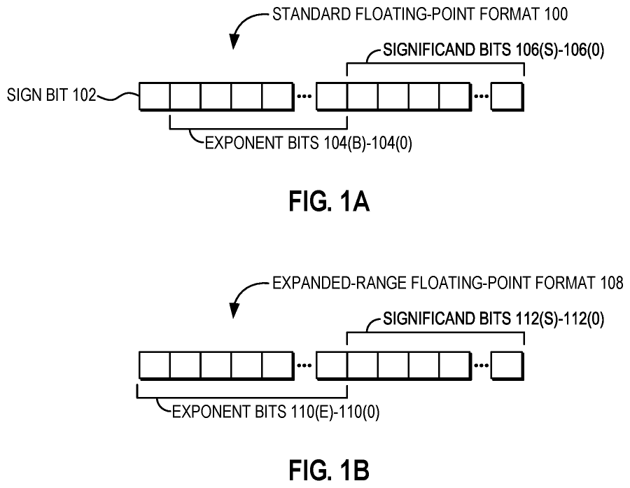

Before discussing operations of the FPU in greater detail, a comparison of a standard floating-point format and the expanded-range floating-point format is first described, with reference to FIGS. 1A and 1B. In this regard, FIG. 1A illustrates an exemplary standard floating-point format 100. The standard floating-point format 100 of FIG. 1A may comprise, e.g., a 16-bit floating-point (FP16) format defined by the Institute of Electrical and Electronics Engineers (IEEE) IEEE-754 standard. The standard floating-point format 100 comprises a sign bit 102, a plurality of exponent bits 104(0)-104(B) (ordered right-to-left in FIG. 1A), and a plurality of significand bits 106(0)-106(S) (ordered right-to-left in FIG. 1A). Aspects in which the standard floating-point format 100 is the IEEE-754 FP16 format may provide five (5) exponent bits 104(0)-104(B) (i.e., B=5) and 11 significand bits (i.e., S=11).

The sign bit 102 of the standard floating-point format 100 is a single bit that indicates a sign of the value represented by the significand bits 106(0)-106(S), with a value of zero (0) indicating a positive sign and a value of one (1) indicating a negative sign. The exponent bits 104(0)-104(B) represents a biased value representing a positive or negative exponent, while the significand bits 106(0)-106(S) represent a normalized value representing the significant digits of a floating-point number as a binary fraction.

As noted above, the use of standard floating-point formats such as FP16 may have negative impacts on processor performance and power consumption. For example, vector normalization is conventionally performed by graphics processing units (GPUs) using an algorithm such as that shown by the pseudo-code below in Table 1 for a vector V comprising vector components X, Y, and Z:

TABLE 1

X_squared = X * X;
Y_squared = Y * Y;
Z_squared = Z * Z;
Length_Squared = X_squared + Y_squared + Z_squared;
One_over_Length = ReciprocalSquareRoot(Length_Squared);
X = X * One_over_Length;
Y = Y * One_over_Length;
Z = Z * One_over_Length;

Note that GPUs conventionally use a reciprocal-square-root operation (referenced as “ReciprocalSquareRoot” in Table 1) instead of a divide operation because the reciprocal-square-root operation is commonly available in GPUs. The ReciprocalSquareRoot function of Table 1 may comprise any conventional algorithm for estimating the reciprocal of a square root of a given floating-point number, such as the fast inverse square root algorithm.

When the algorithm of Table 1 is used to normalize the vector V, the squared terms (i.e., X_squared, Y_squared, and Z_squared) may exceed the range of the FP16 format, even though X, Y, and Z themselves may be represented as FP16 values. This may cause the GPU to encounter an out-of-range or overflow error when executing the algorithm above using FP16 values. Consequently, conventional GPUs must convert the input values (i.e., X, Y, and Z) into 32-bit floating-point (FP32) values, perform the algorithm above using FP32 values, and then convert the results back to FP16. The use of FP32 values and the need for conversion operations results in extra processing overhead and power consumption.

In this regard, FIG. 1B illustrates an expanded-range floating-point format 108 corresponding to the standard floating-point format 100. The expanded-range floating-point format 108 is based on the recognition that, for operations such as squaring that always result in a positive value, the sign bit 102 of the standard floating-point format 100 is redundant. Accordingly, the expanded-range floating-point format 108 corresponding to the standard floating-point format 100 comprises no sign bit, a plurality of exponent bits 110(0)-110(E) (ordered right-to-left in FIG. 1B) that that includes an additional exponent bit relative to the standard floating-point format 100 (i.e., E=B+1), and a plurality of significand bits 112(0)-112(S) (ordered right-to-left in FIG. 1B) that are interpreted in a manner identical to the significand bits 106(0)-106(S) of the standard floating-point format 100. Because the expanded-range floating-point format 108 has the same number S of significand bits as the standard floating-point format 100, the expanded-range floating-point format 108 provides the same level of precision as the standard floating-point format 100. Additionally, the extra exponent bit (i.e., exponent bit 110(E) in FIG. 1B) effectively doubles the range of floating-point values that can be represented using the expanded-range floating-point format 108 relative to the corresponding standard floating-point format 100.

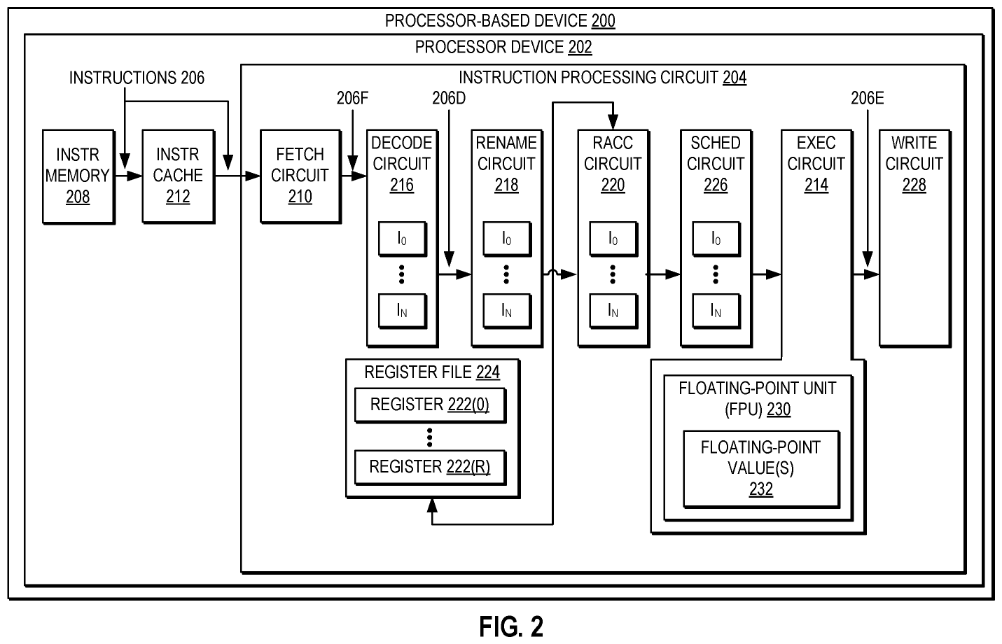

FIG. 2 illustrates an exemplary processor-based device 200 that includes a processor device 202 configured to perform floating-point operations using the expanded-range floating-point format 108 of FIG. 1B. The processor device 202, which also may be referred to as a “processor core” or a “central processing unit (CPU) core,” may be an in-order or an out-of-order processor (OoP), and/or may be one of a plurality of processor devices 202 provided by the processor-based device 200. In the example of FIG. 2, the processor device 202 includes an instruction processing circuit 204 that includes one or more instruction pipelines I₀-I_{N} for processing a plurality of instructions 206 fetched from an instruction memory (captioned as “INSTR MEMORY” in FIG. 2) 208 by a fetch circuit 210 for execution. The instruction memory 208 may be provided in or as part of a system memory (not shown) in the processor-based device 200, as a non-limiting example. An instruction cache (captioned as “INSTR CACHE” in FIG. 2) 212 may also be provided in the processor device 202 to cache the instructions 206 fetched from the instruction memory 208 to reduce latency in the fetch circuit 210.

The fetch circuit 210 in the example of FIG. 2 is configured to provide the instructions 206 as fetched instructions 206F into the one or more instruction pipelines I₀-I_{N} in the instruction processing circuit 204 to be pre-processed, before the fetched instructions 206F reach an execution circuit (captioned as “EXEC CIRCUIT” in FIG. 2) 214 to be executed. The instruction pipelines I₀-I_{N} are provided across different processing circuits or stages of the instruction processing circuit 204 to pre-process and process the fetched instructions 206F in a series of steps that can be performed concurrently to increase throughput prior to execution of the fetched instructions 206F by the execution circuit 214.

With continuing reference to FIG. 2, the instruction processing circuit 204 includes a decode circuit 216 configured to decode the fetched instructions 206F fetched by the fetch circuit 210 into decoded instructions 206D to determine the instruction type and actions required. The instruction type and action required encoded in the decoded instructions 206D may also be used to determine in which instruction pipeline I₀-I_{N} the decoded instructions 206D should be placed. In this example, the decoded instructions 206D are placed in one or more of the instruction pipelines I₀-I_{N} and are next provided to a rename circuit 218 in the instruction processing circuit 204. The rename circuit 218 is configured to determine if any register names in the decoded instructions 206D should be renamed to decouple any register dependencies that would prevent parallel or out-of-order processing.

The instruction processing circuit 204 in the processor device 202 in FIG. 2 also includes a register access circuit (captioned as “RACC CIRCUIT” in FIG. 2) 220. The register access circuit 220 is configured to access a register of a plurality of registers 222(0)-222(R) in a register file 224 based on a mapping entry mapped to a logical register in a register mapping table (RMT) (not shown) of a source register operand of a decoded instruction 206D to retrieve a produced value from an executed instruction 206E in the execution circuit 214. The register access circuit 220 is also configured to provide the retrieved produced value from an executed instruction 206E as the source register operand of a decoded instruction 206D to be executed.

Also, in the instruction processing circuit 204, a scheduler circuit (captioned as “SCHED CIRCUIT” in FIG. 2) 226 is provided in the instruction pipeline I₀-I_{N} and is configured to store decoded instructions 206D in reservation entries until all source register operands for the decoded instruction 206D are available. The scheduler circuit 226 issues decoded instructions 206D that are ready to be executed to the execution circuit 214. A write circuit 228 is also provided in the instruction processing circuit 204 to write back or commit produced values from executed instructions 206E (e.g., to the register file 224, to cache memory, or to system memory).

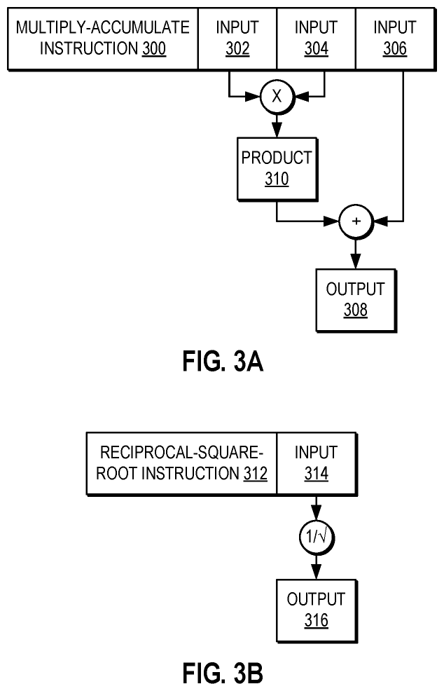

As seen in FIG. 2, the execution circuit 214 of the instruction processing circuit 204 comprises an FPU 230 that is configured to perform floating-point operations, and, in particular, to perform floating-point operations using the expanded-range floating-point format 108 of FIG. 1B. The FPU 230 thus may comprise exponent processing circuitry (not shown) that provides an expanded adder configured to handle an extra exponent bit. In exemplary operation, the FPU 230 performs a floating-point operation using one or more floating-point values (captioned as “FLOATING-POINT VALUE(S)” in FIG. 2) 232 interpreted according to the expanded-range floating-point format 108 of FIG. 1B. The FPU 230 in some aspects may perform the floating-point operation using both the floating-point values 232 interpreted according to the expanded-range floating-point format 108 as well as one or more floating-point values (not shown) that are interpreted according to the standard floating-point format 100 of FIG. 1A. The floating-point operation may be performed by the FPU 230 in response to execution of an expanded-range floating-point instruction provided by an ISA of the processor device 202. Examples of such expanded-range floating-point instructions are discussed in greater detail below with respect to FIGS. 3A and 3B.

FIG. 3A illustrates a multiply-accumulate instruction 300 that may be provided by the ISA of the processor device 202 of FIG. 2 and executed by the FPU 230 using the expanded-range floating-point format 108 of FIG. 1B in some aspects. As seen in FIG. 3A, the multiply-accumulate instruction 300 receives an input value 302, an input value 304, and an input value 306, and returns an output value 308. One or more of the input value 302, the input value 304, the input value 306, and the output value 308 may be interpreted according to the expanded-range floating-point format 108, and thus may be correspond to the one or more floating-point values 232 of FIG. 2. For example, the multiply-accumulate instruction 300 may comprise one or more indicators (not shown) that indicate which of the input value 302, the input value 304, the input value 306, and the output value 308 are to be interpreted according to the expanded-range floating-point format 108, and/or the multiply-accumulate instruction 300 may be hard-coded in the ISA to interpret specific ones of the input value 302, the input value 304, the input value 306, and the output value 308 according to the expanded-range floating-point format 108. As seen in FIG. 3A, when the multiply-accumulate instruction 300 is executed, the FPU 230 multiplies the input value 302 by the input value 304 as a product 310, and then sums the product 310 with the third input value 306 as the output value 308.

FIG. 3B illustrates a reciprocal-square-root instruction 312 that may be provided by the ISA of the processor device 202 of FIG. 2 and executed by the FPU 230 using the expanded-range floating-point format 108 of FIG. 1B, according to some aspects. The reciprocal-square-root instruction 312 of FIG. 3B receives an input value 314 interpreted according to the expanded-range floating-point format 108 (and thus corresponds to the one or more floating-point values 232 of FIG. 2) and returns an output value 316 that is interpreted according to the standard floating-point format 100. Upon executing the reciprocal-square-root instruction 312, the FPU 230 calculates the reciprocal square root of the fourth input value 314 as the output value 316.

In some aspects, such as those in which the multiply-accumulate instruction 300 of FIG. 3A is executed as part of a vector normalization operation, the input value 302 and the input value 304 may be interpreted according to the standard floating-point format 100, while the input value 306 and the output value 308 may be interpreted according to the expanded-range floating-point format 108. That is, the FPU 230 in such aspects is configured to treat the floating-point values represented by the input values 302 and 304 as if defined by the standard floating-point format 100, and to treat the floating-point values represented by the input value 306 and the output value 208 as if defined by the expanded-range floating-point format 108. In this manner, the input value 306 and the output value 208 may represent floating-point values having a larger range than the input values 302 and 304. Similarly, as noted above, when the reciprocal-square-root instruction 312 of FIG. 3B is executed, the input value 314 may be interpreted according to the expanded-range floating-point format 108, while the output value 316 may be interpreted according to the standard floating-point format 100. The multiply-accumulate instruction 300 and the reciprocal-square-root instruction 312 thus could be used to perform the algorithm shown by the pseudo-code below in Table 2 for normalizing a vector V comprising vector components X, Y, and Z:

TABLE 2

Length_Squared = multiply-accumulate(X, X, Length_Squared);
Length_Squared = multiply-accumulate(Y, Y, Length_Squared);
Length_Squared = multiply-accumulate(Y, Y, Length_Squared);
One_over_Length = reciprocal-square-root(Length_Squared);
X = X * One_over_Length;
Y = Y * One_over_Length;
Z = Z * One_over_Length;

The multiply-accumulate instruction 300 of FIG. 3A may also be used in other contexts to carry out floating-point operations using fewer instructions than conventional approaches. For example, ML applications may employ very compact formats, comprising, e.g., two (2) or four (4) bits each, to represent numerical data. These compact values may be packed into a 32-bit word for storage in memory. Processing using the stored compact values is conventionally performed using FP16 values, and thus the stored compact values must be extracted from the 32-bit word and converted to the FP16 format. This conversion process frequently involves scaling the stored compact value into a larger, more usable value. Thus, an algorithm such as that illustrated by the pseudo-code in Table 3 below may be used to extract a stored compact integer value and convert it to an FP16 value:

TABLE 3
unsigned int weight,packed_weight,weight_shift;
short float float_weight;
weight = packed_weight >> weight_shift) & 0xf; //extract packed weight from 32-bit
word
float_weight = (short float) weight; //convert to floating-point value in the range of
0.0 to 15.0
float_weight = weight − 7.0; //offset to enable range of 8.0 to −7.0;

As seen in Table 3, executing this algorithm would require the processor device 202 to execute three (3) instructions. An alternate approach could be used wherein the unsigned int “weight” value treated as a floating-point number representing a denormalized number multiplied by 2⁻²⁵. This approach is illustrated by the algorithm shown by the pseudo-code below in Table 4:

TABLE 4
unsigned int packed_weight,weight_shift;
union uweight (unsigned int weight; short float float_weight); //allow storage to hold
unsigned int or short float;
uweight.weight = packed_weight >> weight_shift) & 0xf; //extract packed weight
from 32-bit word
uweight.float_weight =(2.0 ** 25) * uweight.float_weight − 7.0; //offset to enable
range of 8.0 to −7.0;

In this alternate approach, only two (2) instructions need to be executed, rather than the three (3) instructions executed in the algorithm of Table 3. However, note that the value 2²⁵ (i.e., 2.0**25, or 2 to the 25^{th} power) is not representable as an FP16 number. The algorithm of Table 4 could be used, though, by replacing the last instruction performing the scaling operation with the multiply-accumulate instruction 300 of FIG. 3A. The input value 302 (i.e., 2²⁵ in this example) would be interpreted according to the expanded-range floating-point format 108, and the input value 304 (i.e., unweight.float_weight), the input value 306 (i.e., 7.0), and the output value 308 (i.e., the final value of uweight.float_weight) would be interpreted according to the standard floating-point format 100.

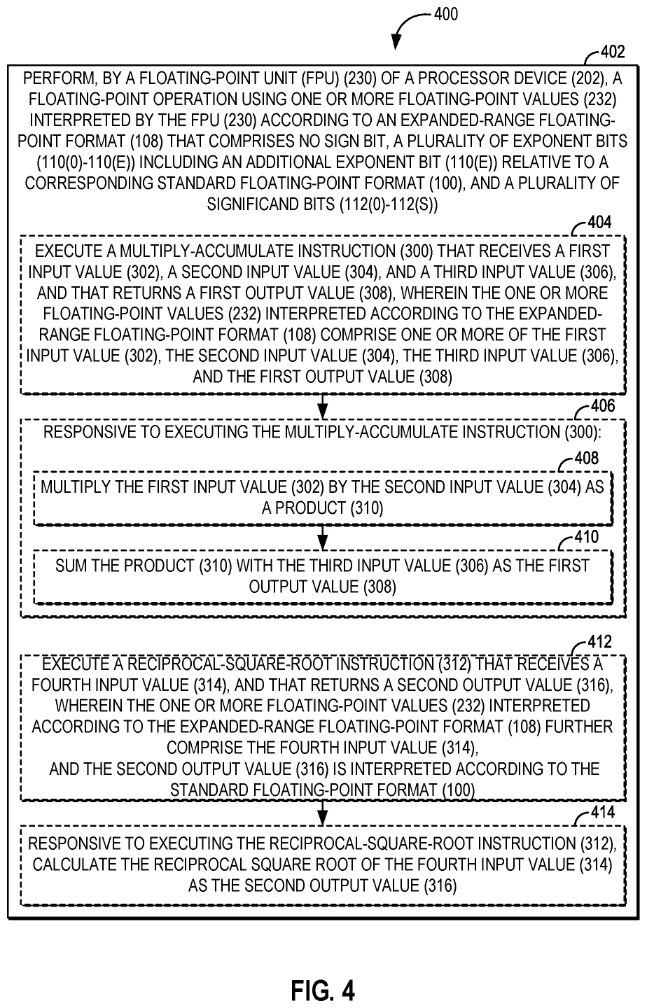

To illustrate operations performed by the FPU 230 of FIG. 2 for performing floating-point operations using the expanded-range floating-point format according to some aspects, FIG. 4 provides a flowchart showing exemplary operations 400. For the sake of clarity, elements of FIGS. 1A-1B, 2, and 3A-3B are referenced in describing FIG. 4. It is to be understood that some aspects may provide that some operations illustrated in FIG. 4 may be performed in an order other than that illustrated herein, and/or may be omitted.

The exemplary operations 400 begin in FIG. 4 with an FPU of a processor device (e.g., the FPU 230 of the processor device 202 of FIG. 2) performing a floating-point operation using one or more floating-point values (such as the floating-point values 232 of FIG. 2) interpreted by the FPU 230 according to an expanded-range floating-point format (e.g., the expanded-range floating-point format 108 of FIG. 1B) that comprises no sign bit, a plurality of exponent bits (such as the exponent bits 110(0)-110(E) of FIG. 1B) including an additional exponent bit 110(E) relative to a corresponding standard floating-point format (e.g., the standard floating-point format 100 of FIG. 1A), and a plurality of significand bits (such as the significand bits 112(0)-112(S) of FIG. 1B) (block 402). As noted above, the expanded-range floating-point format 108 comprises a same number of bits as the corresponding standard floating-point format 100; a count of the plurality of significand bits 112(0)-112(S) of the expanded-range floating-point format 108 is identical to a count of a plurality of significand bits 106(0)-106(S) of the corresponding standard floating-point format 100; and the plurality of significand bits 112(0)-112(S) of the expanded-range floating-point format 108 are interpreted in a manner identical to the plurality of significand bits 106(0)-106(S) of the corresponding standard floating-point format 100. In some aspects, the operations of block 402 for performing the floating-point operation may comprise the FPU 230 executing a multiply-accumulate instruction (such as the multiply-accumulate instruction 300 of FIG. 3A) that receives a first input value, a second input value, and a third input value (e.g., the input value 302, the input value 304, and the input value 306, respectively, of FIG. 3A), and that returns a first output value (such as the output value 308 of FIG. 3A), wherein the one or more floating-point values 232 interpreted according to the expanded-range floating-point format 108 comprise one or more of the first input value 302, the second input value 304, the third input value 306, and the first output value 308 (block 404).

According to some aspects, such as those in which the multiply-accumulate instruction 300 is executed as part of a vector normalization operation, the first input value 302 and the second input value 304 may be interpreted according to the standard floating-point format 100, while the third input value 306 and the first output value 308 may be interpreted according to the expanded-range floating-point format 108. Some aspects, such as those in which the multiply-accumulate instruction 300 is executed as part of a machine learning application, may provide that the first input value 302 is interpreted according to the expanded-range floating-point format 108, while the second input value 304, the third input value 306, and the first output value 308 may be interpreted according to the standard floating-point format 100.

In response to executing the multiply-accumulate instruction 300, the FPU 230 executes a series of operations (block 406). The FPU 230 multiplies the first input value 302 by the second input value 304 as a product (e.g., the product 310 of FIG. 3A) (block 408). The FPU 230 then sums the product 310 with the third input value 306 as the first output value 308 (block 410).

Some aspects may provide that the operations of block 402 for performing the floating-point operation may comprise the FPU 230 executing a reciprocal-square-root instruction (such as the reciprocal-square-root instruction 312 of FIG. 3B) that receives a fourth input value (e.g., the input value 314 of FIG. 3B), and that returns a second output value (such as the output value 316 of FIG. 3B), wherein the one or more floating-point values 232 interpreted according to the expanded-range floating-point format 108 further comprise the fourth input value 314, and the second output value 316 is interpreted according to the standard floating-point format 100 (block 412). In response to executing the reciprocal-square-root instruction 312, the FPU 230 calculates the reciprocal square root of the fourth input value 314 as the second output value 316 (block 414).

The processor device according to aspects disclosed herein and discussed with reference to FIGS. 2 and 4 may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, laptop computer, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, an avionics system, a drone, and a multicopter.

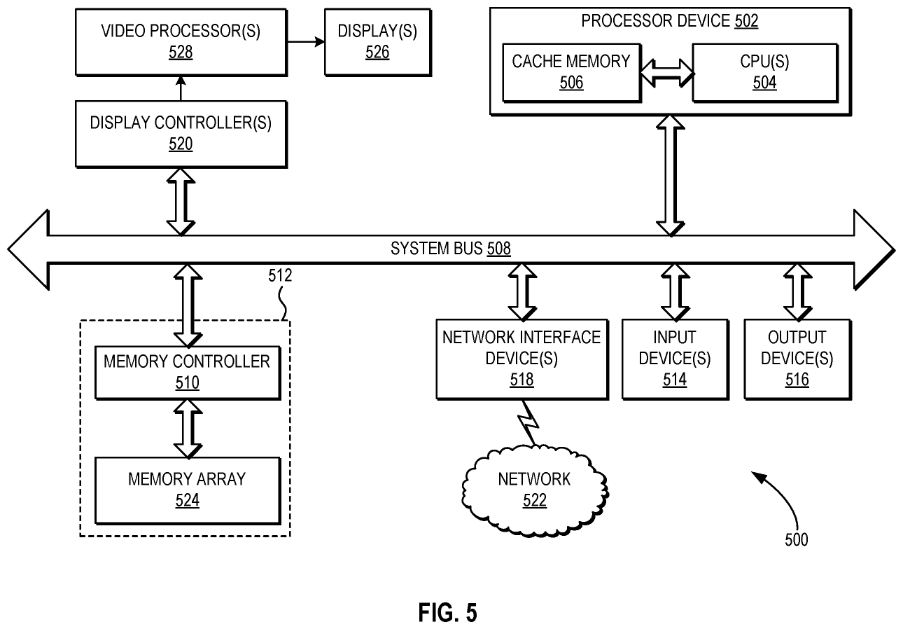

In this regard, FIG. 5 illustrates an example of a processor-based device 500, which corresponds in functionality to the processor-based device 200 of FIG. 2. The processor-based device 500 includes a processor device 502 which corresponds to the processor device 202 of FIG. 2, and which comprises one or more CPUs 504 coupled to a cache memory 506. The CPU(s) 504 is also coupled to a system bus 508 and can intercouple devices included in the processor-based device 500. As is well known, the CPU(s) 504 communicates with these other devices by exchanging address, control, and data information over the system bus 508. For example, the CPU(s) 504 can communicate bus transaction requests to a memory controller 510. Although not illustrated in FIG. 5, multiple system buses 508 could be provided, wherein each system bus 508 constitutes a different fabric.

Other devices may be connected to the system bus 508. As illustrated in FIG. 5, these devices can include a memory system 512, one or more input devices 514, one or more output devices 516, one or more network interface devices 518, and one or more display controllers 520, as examples. The input device(s) 514 can include any type of input device, including, but not limited to, input keys, switches, voice processors, etc. The output device(s) 516 can include any type of output device, including, but not limited to, audio, video, other visual indicators, etc. The network interface device(s) 518 can be any devices configured to allow exchange of data to and from a network 522. The network 522 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 518 can be configured to support any type of communications protocol desired. The memory system 512 can include the memory controller 510 coupled to one or more memory arrays 524.

The CPU(s) 504 may also be configured to access the display controller(s) 520 over the system bus 508 to control information sent to one or more displays 526. The display controller(s) 520 sends information to the display(s) 526 to be displayed via one or more video processors 528, which process the information to be displayed into a format suitable for the display(s) 526. The display(s) 526 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor device. The master devices and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor device, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor device may be a microprocessor, but in the alternative, the processor device may be any conventional processor device, controller, microcontroller, or state machine. A processor device may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor device such that the processor device can read information from, and write information to, the storage medium. In the alternative, the storage medium may be integral to the processor device. The processor device and the storage medium may reside in an ASIC. The ASIC may reside in a remote station. In the alternative, the processor device and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered clauses:

1. A processor device, comprising a floating-point unit (FPU) configured to perform a floating-point operation using one or more floating-point values interpreted by the FPU according to an expanded-range floating-point format that comprises no sign bit, a plurality of exponent bits including an additional exponent bit relative to a corresponding standard floating-point format, and a plurality of significand bits;
wherein:
   the expanded-range floating-point format comprises a same number of bits as the corresponding standard floating-point format;
   a count of the plurality of significand bits of the expanded-range floating-point format is identical to a count of a plurality of significand bits of the corresponding standard floating-point format; and
   the plurality of significand bits of the expanded-range floating-point format are interpreted in a manner identical to the plurality of significand bits of the corresponding standard floating-point format.

2. The processor device of clause 1, wherein the standard floating-point format comprises a 16-bit floating-point format (FP16) defined according to Institute of Electrical and Electronics Engineers (IEEE) Standard for Floating-Point Arithmetic (IEEE-754).

3. The processor device of any one of clauses 1-2, wherein the FPU is configured to perform the floating-point operation by being configured to:
execute a multiply-accumulate instruction that receives a first input value, a second input value, and a third input value, and that returns a first output value,
   wherein the one or more floating-point values interpreted according to the expanded-range floating-point format comprise one or more of the first input value, the second input value, the third input value, and the first output value; and
responsive to executing the multiply-accumulate instruction:
   multiply the first input value by the second input value as a product; and
   sum the product with the third input value as the first output value.

4. The processor device of clause 3, wherein:
the first input value is interpreted according to the standard floating-point format;
the second input value is interpreted according to the standard floating-point format;
the third input value is interpreted according to the expanded-range floating-point format; and
the first output value is interpreted according to the expanded-range floating-point format.

5. The processor device of clause 4, wherein the FPU is further configured to perform the floating-point operation by being further configured to:
execute a reciprocal-square-root instruction that receives a fourth input value, and that returns a second output value,
   wherein:
      the one or more floating-point values interpreted according to the expanded-range floating-point format further comprise the fourth input value; and
      the second output value is interpreted according to the standard floating-point format; and
responsive to executing the reciprocal-square-root instruction, calculate a reciprocal square root of the fourth input value as the second output value.

6. The processor device of clause 5, wherein the floating-point operation comprises a vector normalization operation.

7. The processor device of any one of clauses 3-6, wherein:
the first input value is interpreted according to the expanded-range floating-point format;
the second input value is interpreted according to the standard floating-point format;
the third input value is interpreted according to the standard floating-point format; and
the first output value is interpreted according to the standard floating-point format.

8. The processor device of clause 7, wherein the floating-point operation comprises a scaling operation performed as part of a machine learning (ML) application.

9. The processor device of any one of clauses 1-8, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

10. A processor device, comprising means for performing a floating-point operation using one or more floating-point values interpreted according to an expanded-range floating-point format that comprises no sign bit, a plurality of exponent bits including an additional exponent bit relative to a corresponding standard floating-point format, and a plurality of significand bits;
wherein:
   the expanded-range floating-point format comprises a same number of bits as the corresponding standard floating-point format;
   a count of the plurality of significand bits of the expanded-range floating-point format is identical to a count of a plurality of significand bits of the corresponding standard floating-point format; and
   the plurality of significand bits of the expanded-range floating-point format are interpreted in a manner identical to the plurality of significand bits of the corresponding standard floating-point format.

11. A method for performing floating-point operations using an expanded-range floating-point format in processor devices, comprising performing, by a floating-point unit (FPU) of a processor device, a floating-point operation using one or more floating-point values interpreted by the FPU according to an expanded-range floating-point format that comprises no sign bit, a plurality of exponent bits including an additional exponent bit relative to a corresponding standard floating-point format, and a plurality of significand bits;
wherein:
   the expanded-range floating-point format comprises a same number of bits as the corresponding standard floating-point format;
   a count of the plurality of significand bits of the expanded-range floating-point format is identical to a count of a plurality of significand bits of the corresponding standard floating-point format; and
   the plurality of significand bits of the expanded-range floating-point format are interpreted in a manner identical to the plurality of significand bits of the corresponding standard floating-point format.

12. The method of clause 11, wherein the standard floating-point format comprises a 16-bit floating-point format (FP16) defined according to Institute of Electrical and Electronics Engineers (IEEE) Standard for Floating-Point Arithmetic (IEEE-754).

13. The method of any one of clauses 11-12, wherein performing the floating-point operation comprises:
executing a multiply-accumulate instruction that receives a first input value, a second input value, and a third input value, and that returns a first output value,
   wherein the one or more floating-point values interpreted according to the expanded-range floating-point format comprise one or more of the first input value, the second input value, the third input value, and the first output value; and
responsive to executing the multiply-accumulate instruction:
   multiplying the first input value by the second input value as a product; and
   summing the product with the third input value as the first output value.

14. The method of clause 13, wherein:
the first input value is interpreted according to the standard floating-point format;
the second input value is interpreted according to the standard floating-point format;
the third input value is interpreted according to the expanded-range floating-point format; and
the first output value is interpreted according to the expanded-range floating-point format.

15. The method of clause 14, wherein performing the floating-point operation further comprises:
executing a reciprocal-square-root instruction that receives a fourth input value, and that returns a second output value,
   wherein:
      the one or more floating-point values interpreted according to the expanded-range floating-point format further comprise the fourth input value; and
      the second output value is interpreted according to the standard floating-point format; and
   responsive to executing the reciprocal-square-root instruction, calculating a reciprocal square root of the fourth input value as the second output value.

16. The method of clause 15, wherein the floating-point operation comprises a vector normalization operation.

17. The method of any one of clauses 13-16, wherein:
the first input value is interpreted according to the expanded-range floating-point format;
the second input value is interpreted according to the standard floating-point format;
the third input value is interpreted according to the standard floating-point format; and
the first output value is interpreted according to the standard floating-point format.

18. The method of clause 17, wherein the floating-point operation comprises a scaling operation performed as part of a machine learning (ML) application.

19. A non-transitory computer-readable medium, having stored thereon computer-executable instructions that, when executed, cause a processor device to perform a floating-point operation using one or more floating-point values interpreted by the processor device according to an expanded-range floating-point format that comprises no sign bit, a plurality of exponent bits including an additional exponent bit relative to a corresponding standard floating-point format, and a plurality of significand bits;
wherein:
   the expanded-range floating-point format comprises a same number of bits as the corresponding standard floating-point format;
   a count of the plurality of significand bits of the expanded-range floating-point format is identical to a count of a plurality of significand bits of the corresponding standard floating-point format; and
   the plurality of significand bits of the expanded-range floating-point format are interpreted in a manner identical to the plurality of significand bits of the corresponding standard floating-point format.

20. The non-transitory computer-readable medium of clause 19, wherein the standard floating-point format comprises a 16-bit floating-point format (FP16) defined according to Institute of Electrical and Electronics Engineers (IEEE) Standard for Floating-Point Arithmetic (IEEE-754).

21. The non-transitory computer-readable medium of any one of clauses 19-20, wherein the computer-executable instructions cause the processor device to perform the floating-point operation by causing the processor device to:
execute a multiply-accumulate instruction that receives a first input value, a second input value, and a third input value, and that returns a first output value,
   wherein the one or more floating-point values interpreted according to the expanded-range floating-point format comprise one or more of the first input value, the second input value, the third input value, and the first output value; and
responsive to executing the multiply-accumulate instruction:
   multiply the first input value by the second input value as a product; and
   sum the product with the third input value as the first output value.

22. The non-transitory computer-readable medium of clause 21, wherein:
the first input value is interpreted according to the standard floating-point format;
the second input value is interpreted according to the standard floating-point format;
the third input value is interpreted according to the expanded-range floating-point format; and
the first output value is interpreted according to the expanded-range floating-point format.

23. The non-transitory computer-readable medium of clause 22, wherein the computer-executable instructions further cause the processor device to perform the floating-point operation by further causing the processor device to:
execute a reciprocal-square-root instruction that receives a fourth input value, and that returns a second output value,
   wherein:
      the one or more floating-point values interpreted according to the expanded-range floating-point format further comprise the fourth input value; and
      the second output value is interpreted according to the standard floating-point format; and
responsive to executing the reciprocal-square-root instruction, calculate a reciprocal square root of the fourth input value as the second output value.

24. The non-transitory computer-readable medium of clause 23, wherein the floating-point operation comprises a vector normalization operation.

25. The non-transitory computer-readable medium of any one of clauses 21-24, wherein:
the first input value is interpreted according to the expanded-range floating-point format;
the second input value is interpreted according to the standard floating-point format;
the third input value is interpreted according to the standard floating-point format; and
the first output value is interpreted according to the standard floating-point format.

26. The non-transitory computer-readable medium of clause 25, wherein the floating-point operation comprises a scaling operation performed as part of a machine learning (ML) application.

What is claimed is:

1. A processor device, comprising a floating-point unit (FPU) configured to perform a floating-point operation using one or more floating-point values interpreted by the FPU according to an expanded-range floating-point format that comprises no sign bit, a plurality of exponent bits including an additional exponent bit relative to a corresponding standard floating-point format, and a plurality of significand bits;
wherein:
the expanded-range floating-point format comprises a same number of bits as the corresponding standard floating-point format;
a count of the plurality of significand bits of the expanded-range floating-point format is identical to a count of a plurality of significand bits of the corresponding standard floating-point format; and
the plurality of significand bits of the expanded-range floating-point format are interpreted in a manner identical to the plurality of significand bits of the corresponding standard floating-point format.

2. The processor device of claim 1, wherein the standard floating-point format comprises a 16-bit floating-point format (FP16) defined according to Institute of Electrical and Electronics Engineers (IEEE) Standard for Floating-Point Arithmetic (IEEE-754).

3. The processor device of claim 1, wherein the FPU is configured to perform the floating-point operation by being configured to:
execute a multiply-accumulate instruction that receives a first input value, a second input value, and a third input value, and that returns a first output value,
wherein the one or more floating-point values interpreted according to the expanded-range floating-point format comprise one or more of the first input value, the second input value, the third input value, and the first output value; and
responsive to executing the multiply-accumulate instruction:
multiply the first input value by the second input value as a product; and
sum the product with the third input value as the first output value.

4. The processor device of claim 3, wherein:
the first input value is interpreted according to the standard floating-point format;
the second input value is interpreted according to the standard floating-point format;
the third input value is interpreted according to the expanded-range floating-point format; and
the first output value is interpreted according to the expanded-range floating-point format.

5. The processor device of claim 4, wherein the FPU is further configured to perform the floating-point operation by being further configured to:
execute a reciprocal-square-root instruction that receives a fourth input value, and that returns a second output value,
wherein:
the one or more floating-point values interpreted according to the expanded-range floating-point format further comprise the fourth input value; and
the second output value is interpreted according to the standard floating-point format; and
responsive to executing the reciprocal-square-root instruction, calculate a reciprocal square root of the fourth input value as the second output value.

6. The processor device of claim 5, wherein the floating-point operation comprises a vector normalization operation.

7. The processor device of claim 3, wherein:
the first input value is interpreted according to the expanded-range floating-point format;
the second input value is interpreted according to the standard floating-point format;
the third input value is interpreted according to the standard floating-point format; and
the first output value is interpreted according to the standard floating-point format.

8. The processor device of claim 7, wherein the floating-point operation comprises a scaling operation performed as part of a machine learning (ML) application.

9. The processor device of claim 1, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

10. A processor device, comprising means for performing a floating-point operation using one or more floating-point values interpreted according to an expanded-range floating-point format that comprises no sign bit, a plurality of exponent bits including an additional exponent bit relative to a corresponding standard floating-point format, and a plurality of significand bits;
wherein:
the expanded-range floating-point format comprises a same number of bits as the corresponding standard floating-point format;
a count of the plurality of significand bits of the expanded-range floating-point format is identical to a count of a plurality of significand bits of the corresponding standard floating-point format; and
the plurality of significand bits of the expanded-range floating-point format are interpreted in a manner identical to the plurality of significand bits of the corresponding standard floating-point format.

11. A method for performing floating-point operations using an expanded-range floating-point format in processor devices, comprising performing, by a floating-point unit (FPU) of a processor device, a floating-point operation using one or more floating-point values interpreted by the FPU according to an expanded-range floating-point format that comprises no sign bit, a plurality of exponent bits including an additional exponent bit relative to a corresponding standard floating-point format, and a plurality of significand bits;
wherein:
the expanded-range floating-point format comprises a same number of bits as the corresponding standard floating-point format;
a count of the plurality of significand bits of the expanded-range floating-point format is identical to a count of a plurality of significand bits of the corresponding standard floating-point format; and
the plurality of significand bits of the expanded-range floating-point format are interpreted in a manner identical to the plurality of significand bits of the corresponding standard floating-point format.

12. The method of claim 11, wherein the standard floating-point format comprises a 16-bit floating-point format (FP16) defined according to Institute of Electrical and Electronics Engineers (IEEE) Standard for Floating-Point Arithmetic (IEEE-754).

13. The method of claim 11, wherein performing the floating-point operation comprises:
executing a multiply-accumulate instruction that receives a first input value, a second input value, and a third input value, and that returns a first output value,
wherein the one or more floating-point values interpreted according to the expanded-range floating-point format comprise one or more of the first input value, the second input value, the third input value, and the first output value; and
responsive to executing the multiply-accumulate instruction:
multiplying the first input value by the second input value as a product; and
summing the product with the third input value as the first output value.

14. The method of claim 13, wherein:
the first input value is interpreted according to the standard floating-point format;
the second input value is interpreted according to the standard floating-point format;
the third input value is interpreted according to the expanded-range floating-point format; and
the first output value is interpreted according to the expanded-range floating-point format.

15. The method of claim 14, wherein performing the floating-point operation further comprises:
executing a reciprocal-square-root instruction that receives a fourth input value, and that returns a second output value,
wherein:
the one or more floating-point values interpreted according to the expanded-range floating-point format further comprise the fourth input value; and
the second output value is interpreted according to the standard floating-point format; and
responsive to executing the reciprocal-square-root instruction, calculating a reciprocal square root of the fourth input value as the second output value.

16. The method of claim 15, wherein the floating-point operation comprises a vector normalization operation.

17. The method of claim 13, wherein:
the first input value is interpreted according to the expanded-range floating-point format;
the second input value is interpreted according to the standard floating-point format;
the third input value is interpreted according to the standard floating-point format; and
the first output value is interpreted according to the standard floating-point format.

18. The method of claim 17, wherein the floating-point operation comprises a scaling operation performed as part of a machine learning (ML) application.

19. A non-transitory computer-readable medium, having stored thereon computer-executable instructions that, when executed, cause a processor device to perform a floating-point operation using one or more floating-point values interpreted by the processor device according to an expanded-range floating-point format that comprises no sign bit, a plurality of exponent bits including an additional exponent bit relative to a corresponding standard floating-point format, and a plurality of significand bits;
wherein:
the expanded-range floating-point format comprises a same number of bits as the corresponding standard floating-point format;
a count of the plurality of significand bits of the expanded-range floating-point format is identical to a count of a plurality of significand bits of the corresponding standard floating-point format; and
the plurality of significand bits of the expanded-range floating-point format are interpreted in a manner identical to the plurality of significand bits of the corresponding standard floating-point format.

20. The non-transitory computer-readable medium of claim 19, wherein the standard floating-point format comprises a 16-bit floating-point format (FP16) defined according to Institute of Electrical and Electronics Engineers (IEEE) Standard for Floating-Point Arithmetic (IEEE-754).

21. The non-transitory computer-readable medium of claim 19, wherein the computer-executable instructions cause the processor device to perform the floating-point operation by causing the processor device to:
execute a multiply-accumulate instruction that receives a first input value, a second input value, and a third input value, and that returns a first output value,
wherein the one or more floating-point values interpreted according to the expanded-range floating-point format comprise one or more of the first input value, the second input value, the third input value, and the first output value; and
responsive to executing the multiply-accumulate instruction:
multiply the first input value by the second input value as a product; and
sum the product with the third input value as the first output value.

22. The non-transitory computer-readable medium of claim 21, wherein:
the first input value is interpreted according to the standard floating-point format;
the second input value is interpreted according to the standard floating-point format;
the third input value is interpreted according to the expanded-range floating-point format; and
the first output value is interpreted according to the expanded-range floating-point format.

23. The non-transitory computer-readable medium of claim 22, wherein the computer-executable instructions further cause the processor device to perform the floating-point operation by further causing the processor device to:
execute a reciprocal-square-root instruction that receives a fourth input value, and that returns a second output value,
wherein:
the one or more floating-point values interpreted according to the expanded-range floating-point format further comprise the fourth input value; and
the second output value is interpreted according to the standard floating-point format; and
responsive to executing the reciprocal-square-root instruction, calculate a reciprocal square root of the fourth input value as the second output value.

24. The non-transitory computer-readable medium of claim 23, wherein the floating-point operation comprises a vector normalization operation.

25. The non-transitory computer-readable medium of claim 21, wherein:
the first input value is interpreted according to the expanded-range floating-point format;
the second input value is interpreted according to the standard floating-point format;
the third input value is interpreted according to the standard floating-point format; and
the first output value is interpreted according to the standard floating-point format.

26. The non-transitory computer-readable medium of claim 25, wherein the floating-point operation comprises a scaling operation performed as part of a machine learning (ML) application.
